(19) United States
(12) Patent Application Publication
(10) Pub. No.: US 2012/0019729 A1
(43) Pub. Date: Jan. 26, 2012

(54) SYSTEMS AND METHODS FOR MOBILE VIDEO STREAMING

(76) Inventor: Joshua M. Sniffen, Hewitt, TX (US)

(21) Appl. No.: 13/188,589

(22) Filed: Jul. 22, 2011

Related U.S. Application Data
(60) Provisional application No. 61/366,863, filed on Jul. 22, 2010.

(51) Int. Cl. H04N 5/38

(52) U.S. Cl. 348/723; 348/E05.093

(57) ABSTRACT

Systems and methods for mobile video streaming are disclosed herein. The systems and methods include a system for rugged mobile streaming of video comprising; a chassis having at least one button further comprising: a video processor, configured to receive video signals from an attached device; and; a transmitter configured to transmit video signals.

### PRIORITY CLAIM

The present application claims priority from and the benefit of U.S. Provisional Application No. 61/366,863 filed Jul. 22, 2010, which is herein incorporated by reference.

### BRIEF DESCRIPTION OF THE DRAWINGS

Preferred and alternative examples of the present invention are described in detail below with reference to the following drawings:

FIG. 1 shows a system for mobile video streaming according to an embodiment of the invention;

FIG. 2 is a top view of a mobile video streaming unit according to an embodiment of the invention;

FIG. 3 shows a part list of the components in the mobile video streaming unit according to an embodiment of the invention;

FIG. 4 shows a side view of a silicone pad used in conjunction with the mobile video unit in an embodiment;

FIGS. 5 and 6 show a neoprene foam pad according to an embodiment of the current invention;

FIG. 7 shows a flowchart showing the method of hardware management according to an embodiment of the invention;

FIG. 8 shows various views of the mobile video streaming unit according to embodiments of the invention; and

FIG. 9 shows a method for push and go live according an embodiment of the invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may he practiced without these details or with various combinations of these details. In other instances, well-known systems and methods associated with, but not necessarily limited to, video streaming, rugged computer systems and methods for operating the same may not be shown or described in detail to avoid unnecessarily obscuring descriptions of the embodiments of the invention

Prior approaches for professional grade live video streaming have required bulky, expensive equipment using signal transport such as satellite links. These systems require extensive communications, a high level of technical expertise and come at a very high price. The prior systems are not only bulky, but are very sensitive and are prone to break if dropped or mishandled.

In one embodiment of the current invention, a system and method for mobile video streaming is provided. The system preferably includes a rugged streaming unit that is capable of streaming high definition video received from a camera. The rugged streaming unit is capable of replacing expensive and bulky recording/broadcasting equipment with an ultra-portable, simple, push and go live, all-in-one solution for recording and streaming HD video.

In another embodiment of the current invention, the system's push-and-go-live feature allows the unit to perform its duty on the field without a monitor or any input. The unit is further designed for dynamic and automatic undervolting and clock rate adjustments. This feature not only allows the unit to operate efficiently off a professional battery system, but dramatically reduces the heat output of the system.

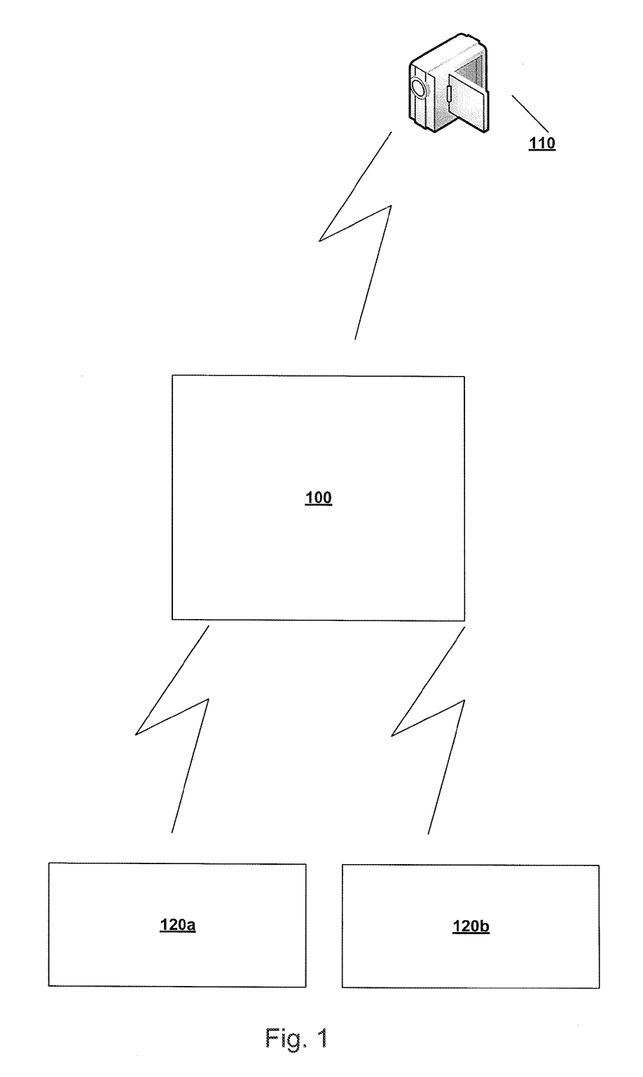

FIG. 1 shows a system for mobile video streaming according to an embodiment of the invention. The system comprises a rugged streaming unit 100 that is in communication with one or more video units 110 in order to capture video. The rugged streaming unit 110 is further in communications with the Internet, an intranet, a network, a server, or another broadcast signal using wired or wireless connection.

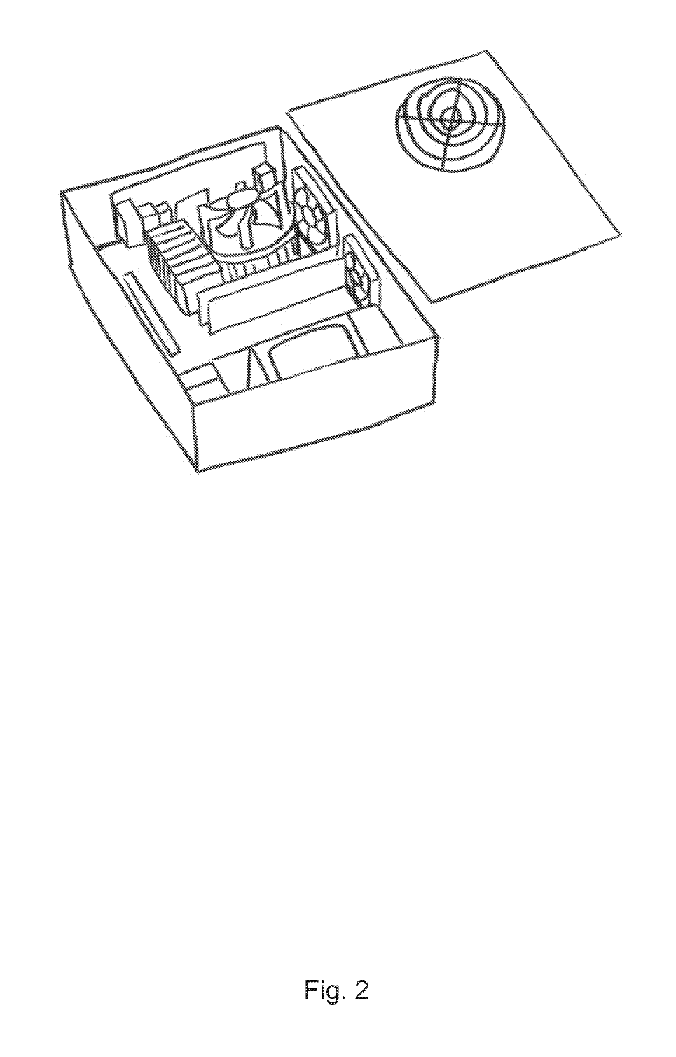

FIG. 2 is a top view of a mobile video streaming unit according to an embodiment of the invention. In an embodiment the dimensions of the unit are preferably 8.27″×10.12″×2.56″ but can be any size or dimensions based on the internal components. The approximate weight is 9.5 lbs, when in the above configuration; however the weight will change based on the particular components selected.

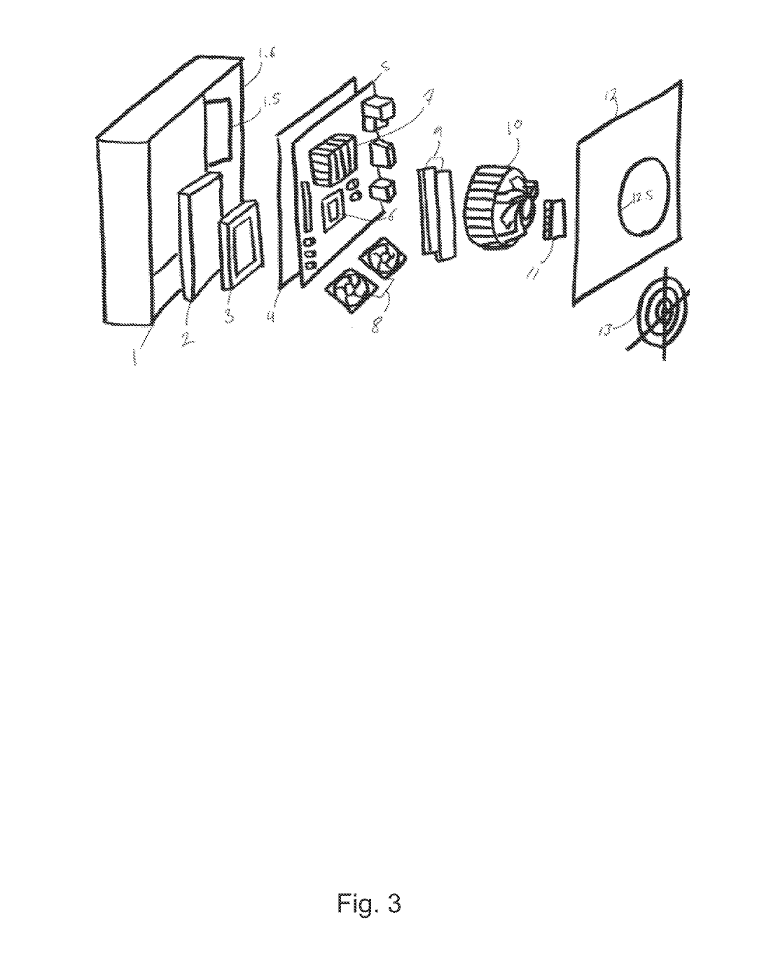

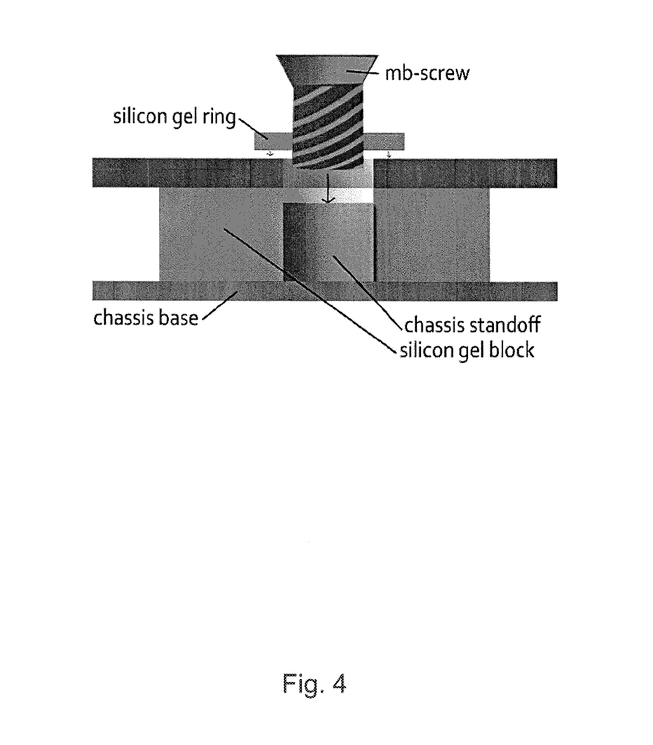

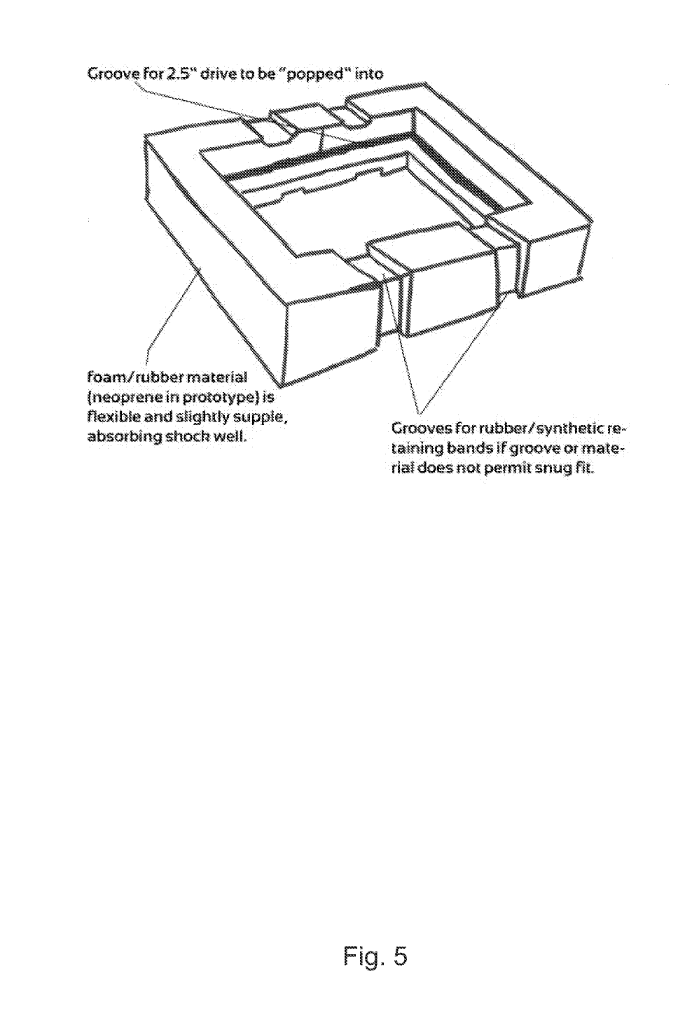

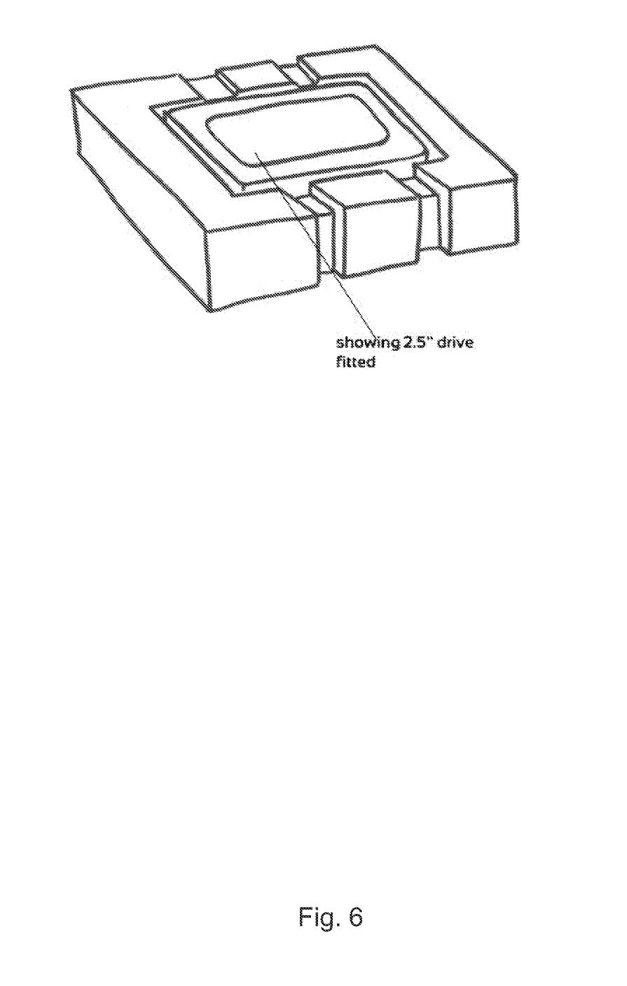

FIG. 3 shows a part list of the components in the mobile video streaming unit according to an embodiment of the invention. In one embodiment, the chassis comprises powder-coated steel and is modified to accommodate the various hardware components. One particular example of the chassis is item #JC205S-B manufactured by Jetway. The unit further comprises: a diameter circular (preferably 120 mm) cut in the removable top panel 12 with a steel fan grill 13 mounted over it. To the right of the IO plate hole on the chassis there is a cut 1.5 (preferably 0.25″×0.5″) to that may accommodate a PCI-E firewire card (not shown). Another cut, approximately 0.005″×0.5″ is made in parallel to the PCI slot in the chassis lid mount lip to allow for the card to be placed without inference by a lip. The chassis motherboard mounting posts were advantageously shortened by 0.125″. This modification provides the motherboard contact to the silica gel pad which resides between the motherboard and chassis, as seen below in FIG. 4. In an embodiment, all other mounting posts, but for the 4 used to secure the two 60 mm fans were removed from the chassis. A neoprene foam pad 2 (as shown in FIGS. 5 and 6 below) glued to the chassis base. The unit further includes, but is not limited to a hard disk 3, a motherboard 5, a CPU 6, and wireless card 7, memory 9, a CPU fan 10 and a power supply 11.

In an embodiment, all cabling in the unit is preferably cut to be the exact needed length to reduce clutter, and improve air circulation. Most cabling runs under the motherboard and between the supporting silicone gel blocks. Cables that needed to be run on the “top” of the motherboard were routed away from heat-producing components. As shown, the hard disk 3 is positioned in the front of the chassis without the need for fasteners. This positioning greatly improves airflow around the CPU 6 and Memory 9.

FIG. 4 shows a side view of a silicon pad used in conjunction with the mobile video unit in an embodiment. Motherboards are becoming increasingly heavy as manufactures add heat dissipation elements to cool powerful on-board components. Power users add to the weight by installing massive heat-sinks to their CPUs and northbridge chipsets—even aftermarket voltage rail heat sinks are mainstream. Protecting individual mounting points on a motherboard are used to protect from damage. By placing, in one embodiment, silicone gel pads slightly taller than the chassis posts around them, and by using an o-ring of the same material, the motherboard can be sandwiched between nothing but shock-absorbing silicon. When the screw mates with the chassis post, the silicon is compressed providing an excellent yet cushioned grip. Not only does this provide shock absorption and prevents cracks from uneven mounts (resulting from not properly tightening all screws), but noise from vibration is also reduced from huge CPU fans and multiple GPU fans.

FIGS. 5 and 6 show a neoprene foam pad according to an embodiment of the current invention. The measurements shown are preferred, but not required. In an embodiment, this pad is preferably glued to the chassis base and has provisions for one or more rubber bands placed in the center of the pad, secured by notches. These bands prevent the disk drive from slipping from the pad, which provides shock-resistance and anti-vibration for spinning hard disks. Because of the material, it can be laid or compressed onto circuit board without the risk of damaging it. The neoprene foam pad further comprises an enclosure A, a channel B for the hard drive 3 rests, and an inner lip C where the hard drive 3 is seated. The underside of the drive 3 being exposed to allow air circulation.

In one embodiment the unit includes, but is not limited to the following software products Microsoft Windows (XP or 7), RMclock, HWmonitor, superPI, Adobe® FME, Macro Recorder 4.6, and CPUID. These products preferably serve two main functions: management of the hardware (dynamic voltage adjustments and throttling) and video transcoding/streaming.

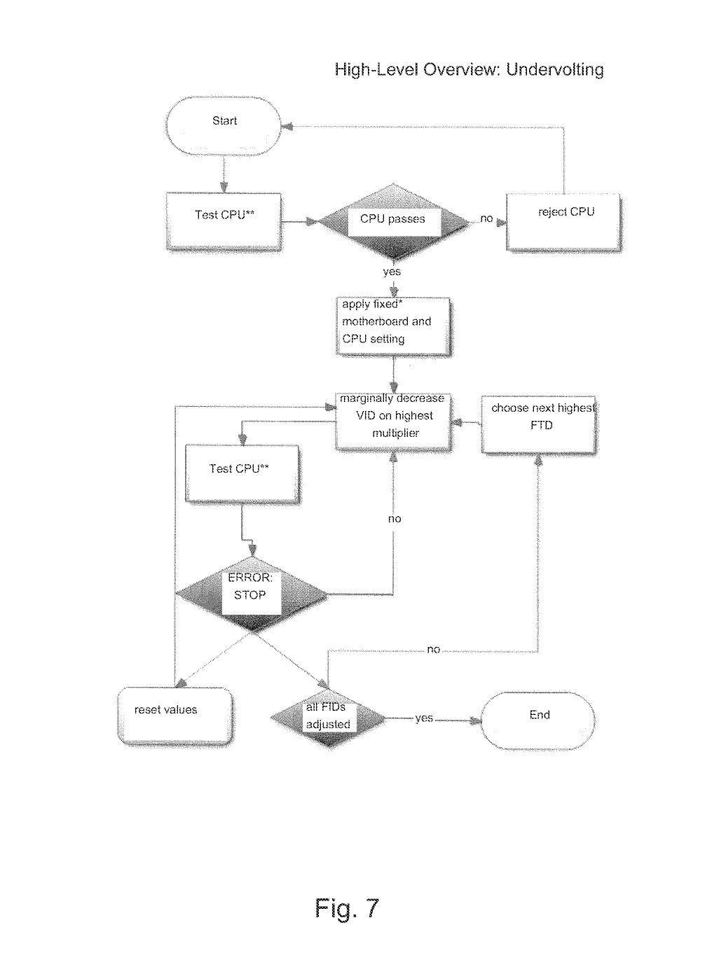

FIG. 7 shows a flowchart showing the method of hardware management according to an embodiment of the invention. Preferably, the CPU's clockrate is adjusted first using the provided utilities in the motherboard's BIOS. CPUID and superPI aid in the overclocking process. When the appropriate clockrate is determined the undervolting process can begin. In one embodiment, the CPU clockrate and applied voltage increase during launch of Adobe® FME, and decrease during other GPU intensive applications. Undervolting and over/underclocking are CPU specific and performed according to a series of steps. The dynamic undervolting and clockrate adjustment allow the unit to squeeze every ounce of power possible from its hardware while never hitting the 150 watt power cap—indeed during the tested recording sessions (at 600 mbps) the unit maintained an average draw of 97 watts. This allows the unit to be a truly while device that can operate off a professional battery pack.

Hardware management further includes, but is not limited to sync TM1 on CPU cores, enable extended throttling, enable mobile profile generator, force profile to override UAC at startup, enable P-state transitions, enable FIDs 0-4 (on Wolfdale chip), disable auto-adjustment of intermediate states VIDs and enable thermal monitors, run Orthos, monitor temps, run Superpi, monitor temps.

Software management includes, but is not limited to Adobe® FME that handles the video transcoding and streaming. In one embodiment, when a set of values are set they can be saved to a profile that launches with FME. Multiple copies of FME can be launched as well, allowing for multiple, simultaneous streams. Using Macro Recorder 4.6, Adobe® FME can launch and run from a saved profile at system startup. This allows the unit to start transcoding and streaming to a specified server 30 seconds from pressing the power button. These buttons could command FME to change stream quality, server locations, or pause and start streaming.

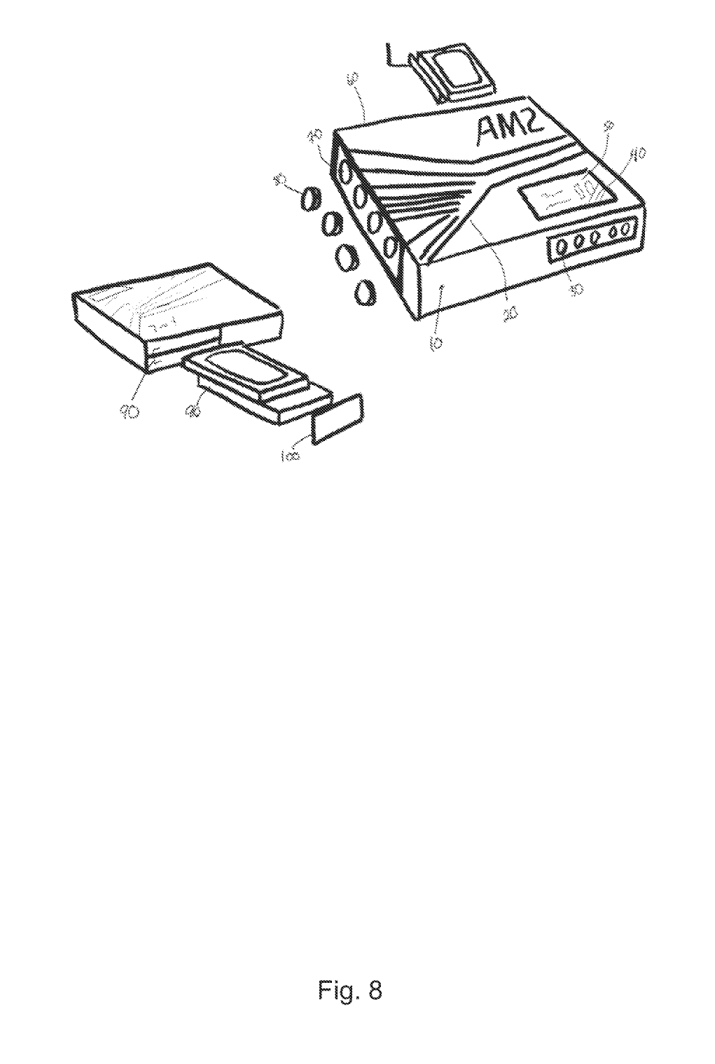

FIG. 8 shows various views of the mobile video unit according to embodiments of the invention. In an embodiment, the Chassis 10 of the unit consists of a two-piece aluminum construction with estimated dimensions of 1.5″×8″×6.5″. The chassis 10′ bottom half serves as a base in which the board preferably bolts directly into. The top half preferably directly touches the motherboards heat-emitting components with a thermal pad offering optimal heat transfer. The two chassis 10 halves may include an o-ring that travels in a groove on the top half around the contacting edges so that when the two halves are screwed together it creates a water-tight seal. This design not only greatly decreases the amount of volume needed to traditionally cool a CPU and GPU because the chassis 10 acts as a heat sink 20 itself (with tremendous surface area) but also is extremely rugged. The back half of the chassis 10 may slant up about 2″ from the back IO plate roughly 30 degrees allowing for an internal, radial fan 60 with forced swirling convection flow. This may provide extra cooling in above average temperatures and not dramatically change the size or form factor of the unit. Waterproof power ports 40, 80 may be included for the firewire and USB connections. The units chassis 10 preferably includes two 2.5″ bays 90 covered by a plate with four screws and another o-ring for water-resistance 100. Removal of this plate allows for the tool-less insertion of 2.5″ solid state disks 910 and reveals a mechanical button linked to the drive ejection system. The SATA3 back-plate may be hooked to the RAID supported SATA3 connectors the motherboard. A, hot swappable RAID system would allow the customer to change out full disks during a recording session, or bring to an editing studio while another set of drives allows the AM2 to be usable in the field,

In an embodiment, the unit would use an inverted LCD screen (with an internal USB connection 40. The screen may be covered by an acrylic faceplate 50 and would display several aspects of the unit's operation, and could be cycled through with one of the units buttons 30. The display screens may include but are not limited to: System health: CPU/GPU temperatures, clockrate and voltages, memory used/max, drive space used/max; Transcoding Session: Current # of streams, target bit-rate/actual bit-rate, CPU used as %, session length, and a center graph displaying actual bit rate+cpu usage as % over time; Transcoding Settings: (profiles would be easier to create while a keyboard and monitor were plugged in, but in the field if the information changes) Current profile, server ip (this would be in lottery format with each number sequence adjustable by pressing other control buttons (which would behave differently on this screen), bit-rate; and/or Production Settings: Record session to disk (yes/no), name session. Input may be handled by the buttons embedded parallel to the screen. These buttons would be recessed and covered with a sliding plate to prevent accidental pressing. These buttons include but are not limited to: change display screen start/stop stream, up, down, on/off.

In an embodiment of the system, on the back side of the chassis would be a small indention where a fold down handle would reside to make transportation more convenient. Four V shaped notches would be indented on the back to allow for a back-plate that could be designed for various popular professional tripods or professional battery packs. The AM2 would have a silicon jacket exposing the majority of its surface area (for heat dissipation) but providing extra shock-resistance and a no-slip grip. Finally, there would be two C-loops on the chassis exterior for attaching a shoulder sling.

In other embodiments, because the unit is a fully functioning PC, a USB monitor, keyboard, or other peripheral can be added to allow for editing media on site.

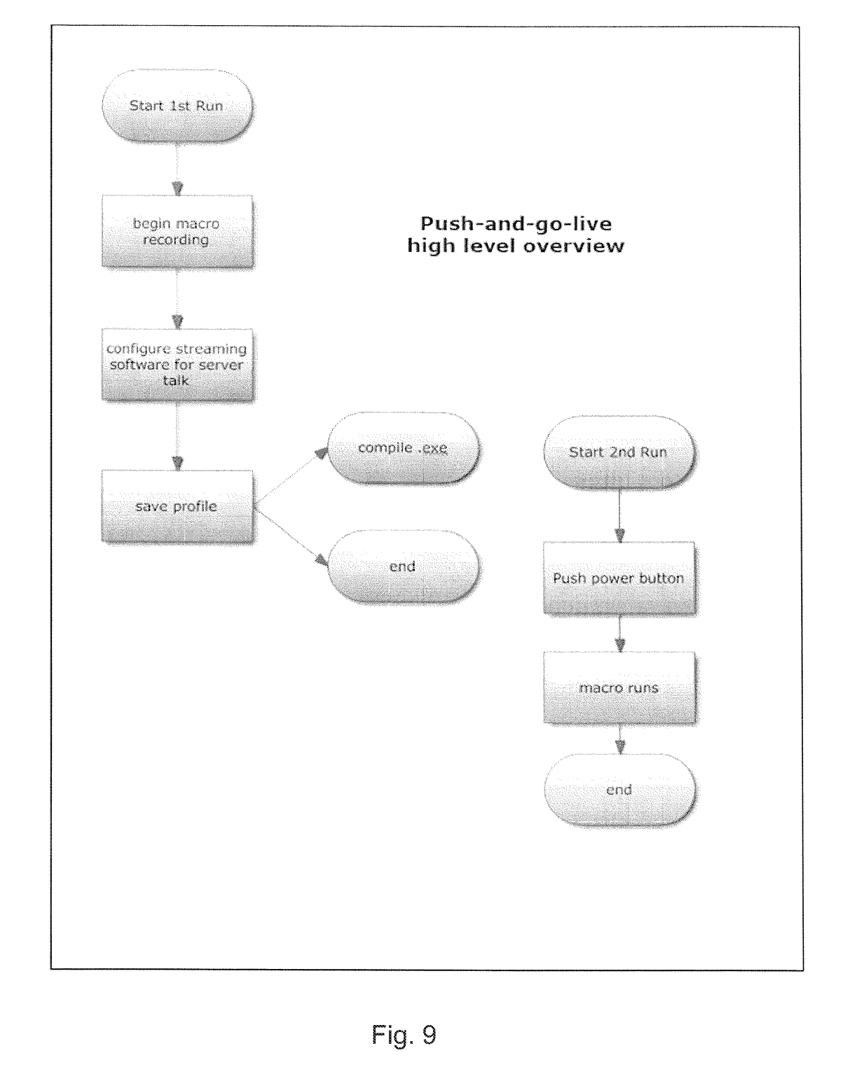

FIG. 9 shows a method for push and go live according an embodiment of the invention. Appendix A includes additional related embodiments.

White the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A system for rugged mobile streaming of video comprising;
a chassis having at least one button further comprising:
a video processor, configured to receive video signals from an attached device; and
a transmitter configured to transmit video signals.
